(19) United States
(12) Patent Application Publication
(10) Pub. No.: US 2015/0294470 A1
(43) Pub. Date: Oct. 15, 2015

(54) METHOD AND SYSTEM FOR DISPARITY VISUALIZATION

(71) Applicants: Anton TE, Glendale, CA (US); Pierrer Hughes ROUTHIER, Playa Del Rey, CA (US); Jesus BARCONS -PALAU, Sunnyvale, CA (US); Richard Edwin GOEDEKEN, Santa Clarita, CA (US); Richard W. KROON, Lake Balboa, CA (US); THOMSON LICENSING, Issy les Moulineaux (FR)

(72) Inventors: Anton Te, Lake Forest, CA (US); Pierre H. Routhier, Varennes (CA); Jesus Barcons-Palau, Redmond, WA (US); Richard E. Goedeken, Santa Clarita, CA (US); Richard W. Kroon, Lake Balboa, CA (US)

(73) Assignee: Thomson Licensing

(21) Appl. No.: 14/443,087

(22) PCT Filed: Nov. 27, 2012
(86) PCT No.: PCT/US2012/066580

§ 371 Date: May 15, 2015

(51) Int. Cl. G06T 7/00; H04N 13/00

(52) U.S. Cl. CPC G06T 7/0051; G06T 7/0075; H04N 13/0022; G06T 2207/10016; G06T 2207/20228

(57) ABSTRACT

A method and system to generate and visualize the distribution of disparities in a stereo sequence and the way they change through time. The data representing the disparities are generated using the disparity and confidence maps of the stereo sequence. For each frame, a histogram of disparity-confidence pairs is generated. These data are later visualized on the screen, presenting the disparity for the full sequence in one graph.

### PRIORITY CLAIM

This application claims the benefit of U.S. Provisional Patent Application No. 61/563261, filed Nov. 23, 2011 entitled “METHOD AND SYSTEM FOR DISPARITY VISUALIZATION” which is incorporated herein by reference.

### FIELD OF THE INVENTION

The present invention relates to a three dimensional video processing system. In particular, the present invention is directed towards a method to generate and visualize the distribution of disparities in a stereo sequence over time.

### BACKGROUND,

Three dimensional (3D) video relies on at least two views of a single image, with each view originating from a different position. For example, humans see a scene with two eyes separated from each other by a certain distance, resulting in a different angle of view of an object. The brain computes the difference between these two angles and generates an estimated distance of the object. Likewise, in 3D video, two different camera angles are captured simultaneously of a scene. A computer then processes the image and determines an object depth primarily in response to the distance in pixels between a pixel in a first image and the corresponding pixel in the second image. This distance is referred to as disparity. The disparity map of a stereo pair gives a distance value for each pixel, which corresponds to the horizontal offset between matching points in the left view and right view images. In some applications, it is desired to study the disparities along time. As such, visualizing the disparity map in a sequential fashion (one frame at a time) can damage both productivity and quality of the work. It would be desirable to be able to distill and visualize the information provided in the disparity map over many frames simultaneously.

### SUMMARY OF THE INVENTION

In one aspect, the present invention involves a method comprising the steps of receiving a video stream comprising a plurality of 3D images, determining at least one disparity value for each of said plurality of 3D images, weighting each of said at least one disparity values with a confidence value to generate a plurality of weighted disparity values, normalizing each of said plurality of weighted disparity values to generate a plurality of normalized disparity values, and generating a graphical representation of said plurality of normalized disparity values where each of said plurality of normalized disparity values corresponds to a different time in said video stream

In another aspect, the invention also involves an apparatus comprising an input wherein said input is operative to receive a video stream comprising a plurality of 3D images, a processor for determining at least one disparity value for each of said plurality of 3D images, weighting each of said at least one disparity values with a confidence value to generate a plurality of weighted disparity values, normalizing each of said plurality of weighted disparity values to generate a plurality of normalized disparity values, and an output for receiving said plurality of normalized disparity values from said processor where each of said plurality of normalized disparity values corresponds to a different time in said video stream.

In another aspect, the invention also involves a method of processing a 3D video signal comprising the steps of receiving a video stream comprising a plurality of paired images, wherein said paired images consist of two images and wherein each of said images having different perspectives of the same scene, determining at least one disparity value for each of said paired images by determining the difference in the location of objects within each of said images, weighting each of said at least one disparity values with a confidence value to generate a plurality of weighted disparity values, normalizing each of said plurality of weighted disparity values to generate a plurality of normalized disparity values, generating a graphical representation of said plurality of normalized disparity values where each of said plurality of normalized disparity values corresponds to a different time in said video stream.

### BRIEF DESCRIPTION OF THE DRAWINGS

FIG. 1 is a block diagram of an exemplary embodiment of a 3D video processing system according to the present invention.

FIG. 2 is a block diagram of an exemplary two pass system according to the present invention.

FIG. 3 is a block diagram of an exemplary one pass system according to the present invention

FIG. 4 is a block diagram of an exemplary live video feed system according to the present invention,

FIG. 5 is a flowchart that illustrates the process of 3D video processing according to the present invention.

FIG. 6 is a graphical representation of a time disparity output according to the present invention.

### DETAILED DESCRIPTION

The characteristics and advantages of the present invention will become more apparent from the following description, given by way of example. One embodiment of the present invention may be included within an integrated video processing system. Another embodiment of the present invention may comprise discrete elements and/or steps achieving a similar result. The exemplifications set out herein illustrate preferred embodiments of the invention, and such exemplifications are not to be construed as limiting the scope of the invention in any manner.

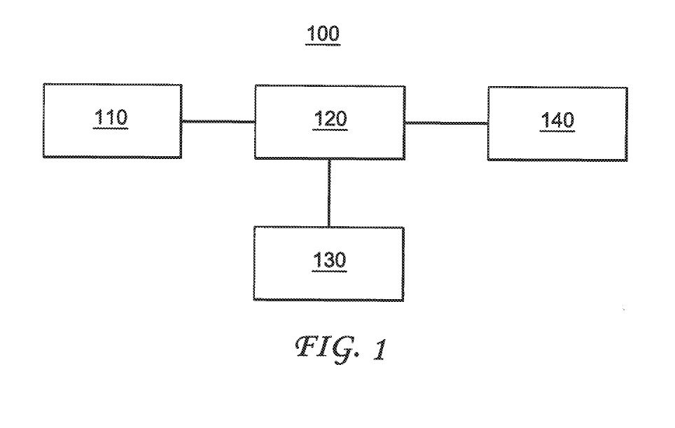

Referring to FIG. 1, a block diagram of an exemplary embodiment of a 3D video processing system 100 according to the present invention is shown. FIG. 1 shows a source of a 3D video stream or image 110, a processor 120, a memory 130, and a display device 140.

The source of a 3D video stream 110, such as a storage device, storage media, or a network connection, provides a time stream of two images. Each of the two images is a different angular view of the same scene. Thus, the two images will have slightly different characteristics in that the scene is viewed from different angles separated by a horizontal distance, similar to what would be seen by each individual eye in a human. Each image may contain information not available in the other image due to some objects in the foreground of one image hiding information available in the second image due to camera angle. For example, one view taken closer to a corner would see more of the background behind the corner than a view take further away from the corner. This results in only one point being available for a disparity map and therefore generating a less reliable disparity map.

The processor 120 receives the two images and generates a disparity value for a plurality of points in the image. These disparity values can be used to generate a disparity map, which shows the regions of the image and their associated image depth. The image depth of a portion of the image is inversely proportional to the disparity value. The processor then stores these disparity values on a memory 130 or the like.

After further processing by the processor 120 according to the present invention, the apparatus can display to a user a disparity map for a pair of images, or can generate a disparity time comparison according to the present invention. These will be discussed in further detail with reference to other figures. These comparisons are then displayed on a display device, such as a monitor, or a led scale, or similar display device.

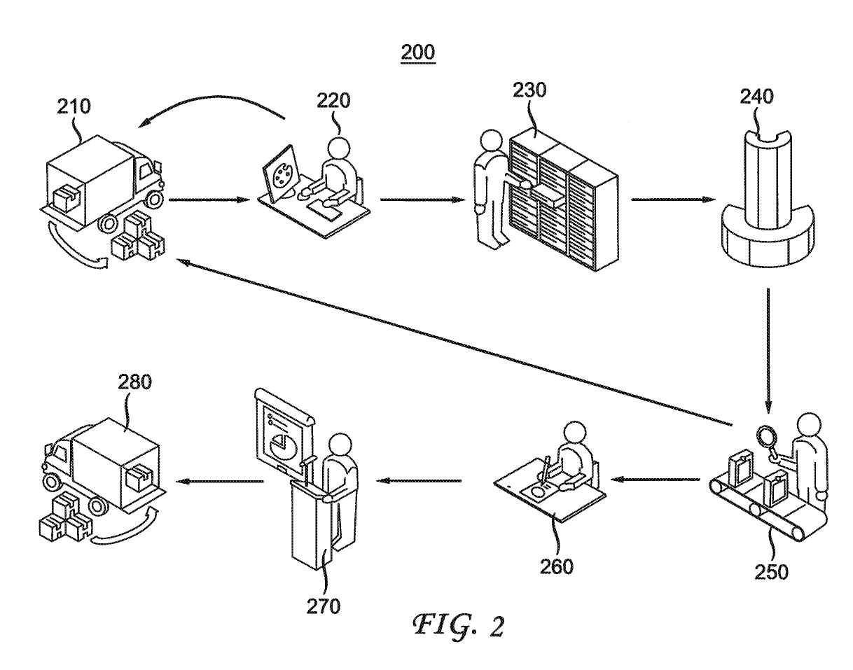

Referring now to FIG. 2, a block diagram of an exemplary two pass system 200 according to the present invention is shown. The two pass system is operative to receive content 210 via storage media or network. The system then qualifies the content 220 to ensure that the correct content has been received. If the correct content has not been received, it is returned to the supplier or customer. If the correct content has been received, it is loaded 230 into the system according to the present invention.

Once loaded into the exemplary 3D video processing system according to the present invention, the 3D video images are analyzed to calculate and record depth information 240. This information is stored in a storage media. After analysis, an analyst or other user will then review 250 the information stored in the storage media and determine if the some or all of the analysis must be repeated with different parameters. The analyst may also reject the content. A report is then prepared for the customer 260, and the report is presented to the customer 270 and any 3D video content is returned to the customer 280. The two pass processes permits an analyst to optimize the results based on a previous analysis.

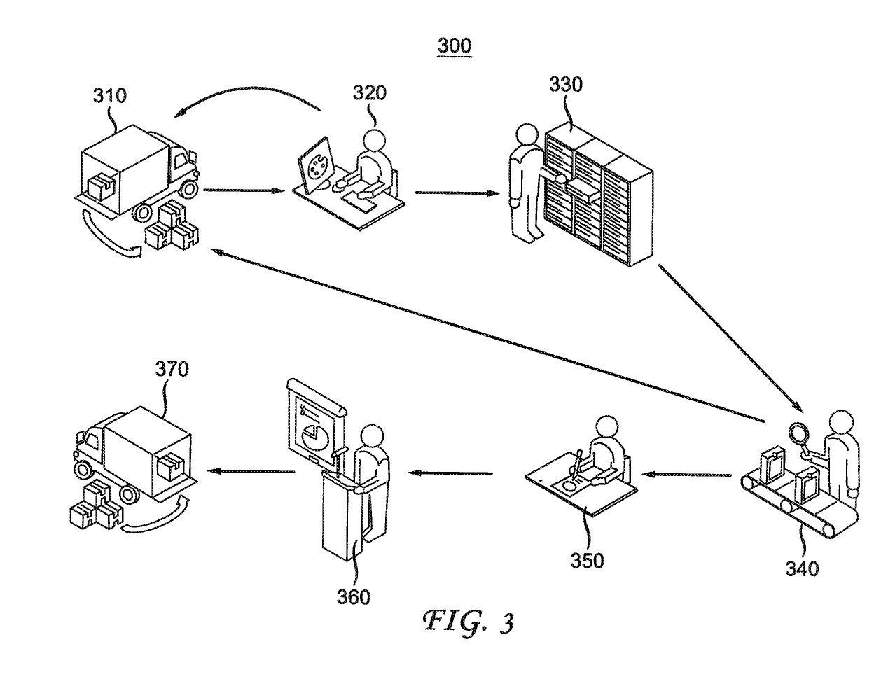

Referring now to FIG. 3 a block diagram of an exemplary one pass system according to the present invention is shown. The one pass system is operative to receive content 310 via storage media or network. The system then qualifies the content 320 to ensure that the correct content has been received. If the correct content has not been received, it is returned to the supplier or customer. If the correct content has been received, it is loaded 330 into the system according to the present invention.

Once loaded into the exemplary 3D video processing system according to the present invention, the 3D video images are analyzed to calculate and record depth information 340, generate depth map and perform automated analysis live during playback. This information is may stored in a storage media. An analyst will review the generated information. Optionally the system may dynamically down-sample to maintain real-time playback. A report may optionally be prepared for the customer 350, and the report is presented to the customer 360 and any 3D video content is returned to the customer 370.

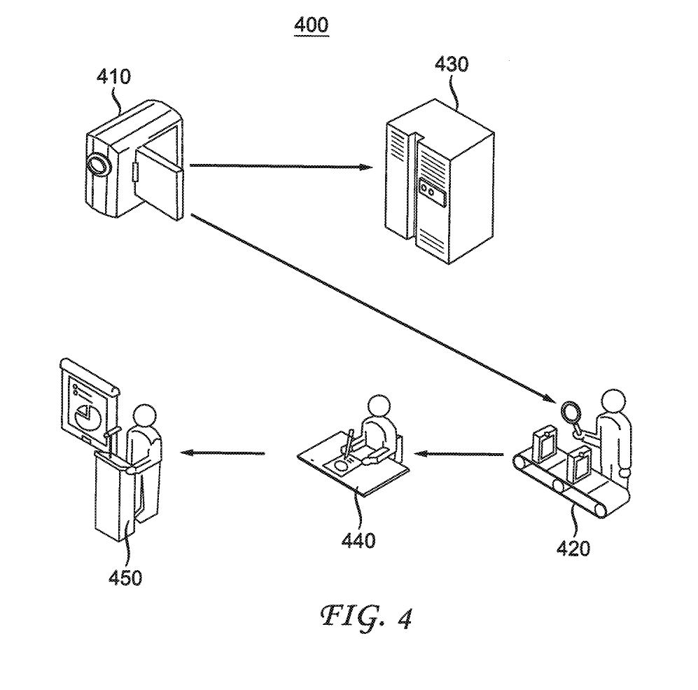

Referring now to FIG. 4, a block diagram of an exemplary live video feed system 400 according to the present invention is shown. The live video feed system 400 is operative to receive a 3D video stream with either two separate channels for left and right eye or one frame compatible feed 410. An operator initiates a prequalification review of the content 420. They analyst may adjust parameters of the automated analysis and or limit particular functions to ensure real time performance. The system may record content and/or depth map to a storage medium for later detailed analysis 430. The analyst then prepares the certification report 440 and returns the report to the customer 450. These steps may be automated.

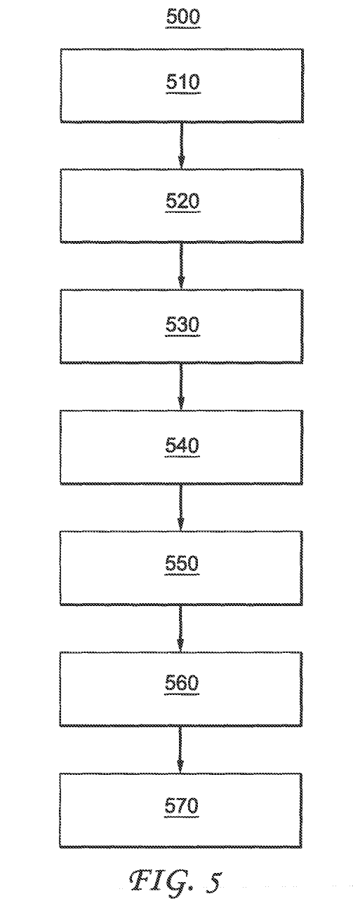

Referring now to FIG. 5, a flowchart that illustrates an exemplary embodiment of the process of 3D video processing 500 according to the present invention is shown.

First, the system receives the 3D video stream as a series of paired images 510. Each image in a pair represents a view of the scene as taken from a slightly different perspective. These images may be transmitted as part of a live 3D video stream. Alternatively, they can be transmitted via a media storage device, such as a hard drive, flash memory, or optical disk, or the images may be received from a remote storage location via a network connection.

The system then performs a disparity calculation and generates a disparity map 520. A disparity map, sometimes called a depth map, is an array of values that contains information relating to the distance of the surfaces of scene objects from a viewpoint. In one exemplary embodiment of the present disclosure, the values of the disparity map are stored as a “short integer” data type, hence the possible range of disparities is between −32768 and 32767.

The system then generates a confidence map using the generated disparity map 530. To improve upon the initial disparity estimates generated in the previous step, a subsequent refinement step is commonly employed. The accuracy of disparity map calculations inherently depend on the underlying image content. For some regions of an image, it may be difficult or impossible to establish accurate point correspondences. This results in disparity estimates of varying accuracy and reliability. A confidence map may then be generated which models the reliability of each disparity match. In an exemplary embodiment, the values of the confidence map are stored in an unsigned char type, and the values can vary from 0 for very low confidence up to 255 for very high confidence.

The system then generates a histogram weighted with the confidences of the disparity values 540. An array Hᵢ of histograms, where the sub-index i indicates frame number, is computed for every disparity map with its associated confidence map. Within each histogram, the bins represent disparity values, and for every pixel's disparity value in the disparity map, its correspondent confidence value is added to the corresponding bin. The array Hᵢ can be interpreted as a histogram weighted with the confidences of the disparity values. In our particular embodiment, the size of the histogram is 512 bins.

To generate Hᵢ let Dᵢ be the disparity map and Cᵢ its associated confidence map for the i-th frame, both expressed as a column vector. Let Hᵢ be an array of size s, initialized to zeroes, which will contain the result of the procedure. Then, the procedure is as follows (note that the center of the histogram is s/2):
for j in 0 . . . length(Dᵢ)−1:

p=min(max(0, Dᵢ[j]+s/2), s−1)

Hᵢ[p]=Hᵢ[p]+Cᵢ[j]

H={H₀, H₁, . . . , H_{N}} is the set of all the histograms in the video sequence.

d=L[(1−p)*(N−1)]

The system then normalizes the histogram 550. In order to visualize the histograms consistently on a video display device, they have to be normalized. In the exemplary embodiment of the present disclosure, the common variable d that will divide all the data in H is chosen using the steps of procedure 2. As d is not necessarily defined as the maximum value in H, during the normalization process, all the values greater than 1 will be clipped to 1.

To generate Ĥ, the normalized value of H, a percentage factor is applied that offsets the normalizing parameter from the peak (in an exemplary embodiment this value is set as 0.95).

The system then optionally applies user defined thresholds 560. The user s may set predefined thresholds which may indicate undesirable conditions, such as hyperconvergence or hyperdivergence. These thresholds may be indicated on the display by changing color of the histogram. For example, when the value of the histogram exceeds a certain threshold, the color is changed to red making easier for a user to recognize the condition is present.

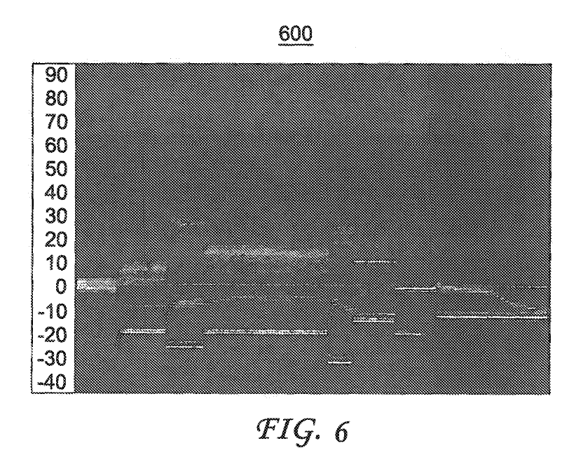

The system then couples the histogram to a display device 570. The set of Ĥ is finally rendered on the screen. As the bins of Ĥ directly match to disparity values, different colors can be used to indicate if the disparity is between user-defined thresholds, like error and warning thresholds for hyper convergence and hyper divergence (see FIG. 5). The GUI widget in which this data is visualized allows the user to zoom in and out vertically (disparity range) and horizontally (frame range), and move in both axes (see FIGS. 1, 2 and 3). Also, a gamma correction operation can be applied to the data before the visualization of Ĥ on the screen. See FIGS. 6 and 7.

Turning now to FIG. 6, a graphical representation of a time disparity histogram output according to the present invention is shown. The way the pair of disparity-confidence data is distilled and visualized allows the user to quickly assess the range of disparities of the stereo video sequence. This not only improves performance as it is possible to see, in a fraction of a second, the disparities of the whole sequence, but also minimizes errors. From the application point of view, the confidence of the disparities play a very important role in the method. From the users point of view, as all the data is visualized consistently at the same time, there is less risk of missing detail in comparison with visualizing the disparity maps in a sequential fashion.

The method according to the present invention may be practiced, but is not limited to, using the following hardware and software: SIT-specified 3D Workstation, one to three 2D monitors, a 3D Monitor (frame-compatible and preferably frame-sequential as well), Windows 7 (for workstation version), Windows Server 2008 R2 (for server version), Linux (Ubuntu, CentOS), Apple Macintosh OSX, Adobe Creative Suite software and Stereoscopic Player software.

It should be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces.

The present description illustrates the principles of the present disclosure. It will thus be appreciated that those skilled in the art will be able to devise various arrangements that, although not explicitly described or shown herein, embody the principles of the disclosure and are included within its spirit and scope.

All examples and conditional language recited herein are intended for informational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herewith represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

Although embodiments which incorporate the teachings of the present disclosure have been shown and described in detail herein, those skilled in the art can readily devise many other varied embodiments that still incorporate these teachings. Having described preferred embodiments for a method and system for disparity visualization (which are intended to be illustrative and not limiting), it is noted that modifications and variations can be made by persons skilled in the art in light of the above teachings.

1. A method comprising the steps of:
receiving a video stream comprising a plurality of 3D images;
determining at least one disparity value for each of said plurality of 3D images;
weighting each of said at least one disparity values with a confidence value to generate a plurality of weighted disparity values;
normalizing each of said plurality of weighted disparity values to generate a plurality of normalized disparity values; and
generating a graphical representation of said plurality of normalized disparity values where each of said plurality of normalized disparity values corresponds to a different time in said video stream.

2. The method of claim 1 wherein said graphical representation is generated in a plurality of colors in response to a user defined threshold.

3. The method of claim 1 wherein said graphical representation is generated in differing graphical attributes in response to a user defined threshold.

4. The method of claiml wherein said graphical representation is generated in differing graphical attributes in response to a defined threshold.

5. The method of claim 1 further comprising the step of storing at least one of said at least one disparity value for each of said plurality of 3D images, said plurality of weighted disparity values, or said plurality of normalized disparity values.

6. The method of claim 1 further comprising the step of generating a report in response to said generating a graphical representation of said plurality of normalized disparity values.

7. An apparatus comprising:
an input wherein said input is operative to receive a video stream comprising a plurality of 3D images;
a processor for determining at least one disparity value for each of said plurality of 3D images, weighting each of said at least one disparity values with a confidence value to generate a plurality of weighted disparity values, normalizing each of said plurality of weighted disparity values to generate a plurality of normalized disparity values; and
an output for receiving said plurality of normalized disparity values from said processor where each of said plurality of normalized disparity in values corresponds to a different time in said video stream.

8. The apparatus of claim 7 further comprising a memory, wherein said memory is coupled to said processor and is operative to store at least one of said at least one disparity value for each of said plurality of 3D images, said plurality of weighted disparity values, or said plurality of normalized disparity values.

9. The apparatus of claim 7 wherein said output is further coupled to a display device operative to generate a graphical representation of said plurality of normalized disparity values.

10. The apparatus of claim 9 wherein said graphical representation is generated in a plurality of colors in response to a user defined threshold.

11. The apparatus of claim 9 wherein said graphical representation is generated in differing graphical attributes in response to a user defined threshold.

12. The apparatus of claim 9 wherein said graphical representation is generated in differing graphical attributes in response to a defined threshold.

13. The apparatus of claim 7 wherein said processor is further operative to generate a report in response to said generating a plurality of normalized disparity values.

14. A method of processing a 3D video signal comprising the steps of:
receiving a video stream comprising a plurality of paired images, wherein said paired images consist of two images and wherein each of said images having different perspectives of the same scene;
determining at least one disparity value for each of said paired images by determining the difference in the location of objects within each of said images;
weighting each of said at least one disparity values with a confidence value to generate a plurality of weighted disparity values;
normalizing each of said plurality of weighted disparity values to generate a plurality of normalized disparity values; and
generating a graphical representation of said plurality of normalized disparity values where each of said plurality of normalized disparity values corresponds to a different time in said video stream.

15. The method of processing a 3D video signal of claim 14 wherein said graphical representation is generated in a plurality of colors in response to a user defined threshold.

16. The method of processing a 3D video signal of claim 14 wherein said graphical representation is generated in differing graphical attributes in response to a user defined threshold.

17. The method of processing a 3D video signal of claiml4 wherein said graphical representation is generated in differing graphical attributes in response to a defined threshold.

18. The method of processing a 3D video signal of claim 14 further comprising the step of storing at least one of said at least one disparity value for each of said plurality of paired images, said plurality of weighted disparity values, or said plurality of normalized disparity values.

19. The method of processing a 3D video signal of claim 14 further comprising the step of generating a report in response to said generating a graphical representation of said plurality of normalized disparity values.

20. The method of processing a 3D video signal of claim 14 wherein said confidence value is generated in response to an determining the location of objects within each of said images.
